(19) United States
(12) Patent Application Publication
(10) Pub. No.: US 2012/0050212 A1
(43) Pub. Date: Mar. 1, 2012

(54) TOUCH SCREEN

(75) Inventors: Dong Sik Yoo, Gyunggi-do (KR); Yong Soo Oh, Gyunggi-do (KR); Jong Young Lee, Gyunggi-do (KR); Yun Ki Hong, Gyunggi-do (KR); Hee Bum Lee, Gyunggi-do (KR); Kyoung Soo Chae, Gyunggi-do (KR)

(73) Assignee: SAMSUNG ELECTRO-MECHANICS CO., LTD., Gyunggi-do (KR)

(21) Appl. No.: 12/949,599

(22) Filed: Nov. 18, 2010

(30) Foreign Application Priority Data
Aug. 26, 2010 (KR) 1020100082970

(51) Int. Cl. G06F 3/045

(52) U.S. Cl. 345/174

(57) ABSTRACT

Disclosed herein is a touch screen, including: a first transparent electrode formed on a first transparent substrate; a second transparent electrode formed on a second transparent substrate opposite to the first transparent substrate and being in contact with the first transparent electrode when a touched input is generated to sense a change in resistance or voltage; an adhesive layer bonding an outer side of the first transparent substrate to an outer side of the second transparent substrate and having an opening formed therein; and a plurality of dot spacers movably formed in the opening, whereby, it is possible to accurately measure the positions of the touched input due to the movement of the dot spacers by the touched input.

### CROSS REFERENCE TO RELATED APPLICATION

This application claims the benefit of Korean Patent Application No. 10-2010-0082970, filed on Aug. 26, 2010, entitled “Touch Screen”, which is hereby incorporated by reference in its entirety into this application.

### BACKGROUND OF THE INVENTION

1. Technical Field

The present invention relates to a touch screen.

2. Description of the Related Art

In particular, as electronic technology continuously develops, personal computers and portable transmitters etc. process texts and graphics, using a variety of input devices, such as a keyboard, a mouse, a digitizer, etc. These input devices, however, have been developed in consideration of the expanding usage of personal computers, such that they are difficult to be applied to portable devices that are recently reduced in size and thickness. Therefore, touch screens are on the rise as an input device appropriate for portable devices.

Touch screens, devices generally installed in display devices to select users' desired information, have various advantages of being simply operated with minimal malfunction in a small space, while being very compatible with IT devices. Owing to these advantages, the touch screen is widely used in various fields such as industry, traffic, service, medicine, mobile, and the like.

Meanwhile, the touch screen is classifiable as a resistive type, a capacitive type, an electromagnetic type, a surface acoustic wave (SAW) type, an infrared type, and so on. Among others, the resistive type being relatively inexpensive and being able to accurately detect the positions of the touched input is widely used.

FIG. 1 is a cross-sectional view of a resistive touch screen 10 according to the prior art. Hereinafter, the touch screen 10 according to the prior art will be described with reference to the figure.

As shown in FIG. 1, the touch screen 10 according to the prior art includes a transparent substrate 11, an indium tin oxide (ITO) electrode 12, an electrode 13, a double-sided adhesive tape (DAT) 14, and a dot spacer 15.

Herein, the transparent substrate 11 is formed of two sheets of an upper transparent substrate 11a and a lower transparent substrate 11b, wherein the ITO electrode 12 is formed on one surface of the transparent substrate 11. In addition, the electrode 13, which is a unit applying voltage to the ITO electrode 12, is formed on one surface of the transparent substrate 11 to be connected to the ITO electrode 12. Meanwhile, the double-sided adhesive tape 14 is provided on the outer side between the upper transparent substrate 11a and the lower transparent substrate 11b to bond the upper transparent substrate 11a to the lower transparent substrate 11b. In addition, the dot spacer 15 bonded to the lower ITO electrode 12b is formed on the inner side between the transparent substrates 11a and 11b.

However, the dot spacer 15 is fixed to the lower ITO electrode 12b in the touch screen 10 according to the prior art, such that it is difficult to measure an accurate position. More specifically, when the interval between the fixed dot spacers 15 is too wide, the position of the touched input is not specified, such that it is difficult to accurately measure the position thereof. When the interval between the fixed dot spacers 15 is too narrow, space in which the upper ITO electrode 12a is in contact with the lower ITO electrode 12b is not sufficient, such that the touched input itself cannot be sensed.

In addition, a metal screen formed with an opening is used while forming the dot spacer 15, such that a process is complicated. As a result, manufacturing costs and manufacturing time of the touch screen are increased.

### SUMMARY OF THE INVENTION

The present invention has been made in an effort to provide a touch screen that can accurately detect positions of a touched input by changing an interval between dot spacers.

The present invention has been also made in an effort to provide a touch screen that reduces manufacturing costs and manufacturing time by simplifying a manufacturing process of a dot spacer.

A touch screen according to a preferred embodiment of the present invention includes: a first transparent electrode formed on a first transparent substrate; a second transparent electrode formed on a second transparent substrate opposite to the first transparent substrate and being in contact with the first transparent electrode when a touched input is generated to sense a change in resistance or voltage; an adhesive layer bonding an outer side of the first transparent substrate to an outer side of the second transparent substrate and having an opening formed therein; and a plurality of dot spacers movably formed in the opening.

Herein, when the touched input is generated, the plurality of dot spacers are moved and closely adhered to each other in the opening and the first transparent electrode is in contact with the second transparent electrode in a touched region that is a space between the plurality of dot spacers.

A width of the touched region is 78.5 mm² or less.

The dot spacer has a spherical shape.

The touch screen further includes electrodes formed on each of the first transparent substrate and the second transparent substrate to apply voltage to the first transparent electrode and the second transparent electrode.

The touch screen further includes a lubrication member filled in the opening.

A diameter of the dot spacer is 20 to 40 μm.

### BRIEF DESCRIPTION OF THE DRAWINGS

FIG. 1 is a cross-sectional view of a resistive touch screen according to the prior art;

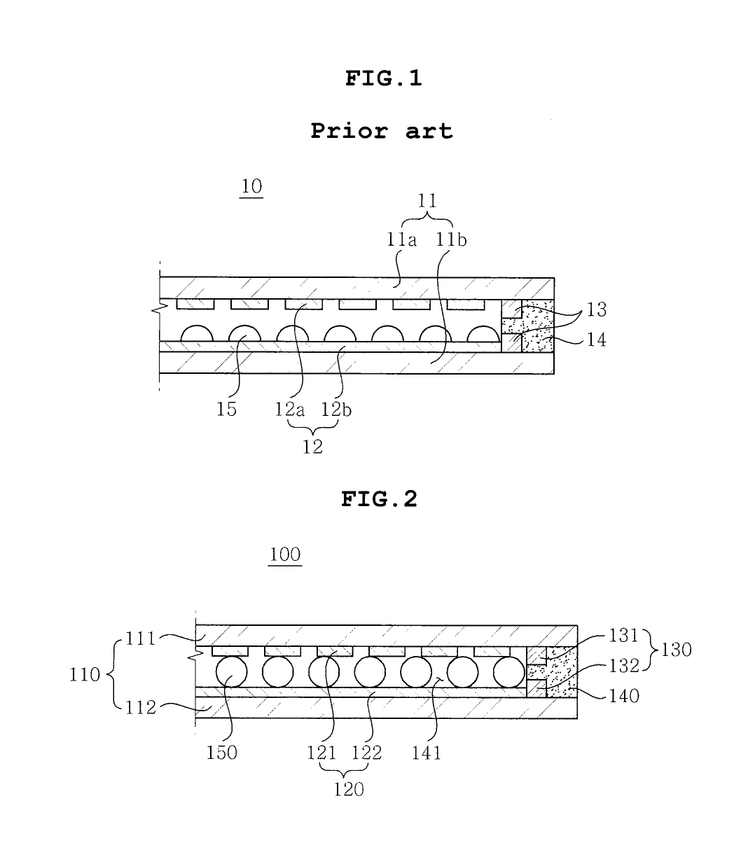

FIG. 2 is a cross-sectional view of a touch screen according to a preferred embodiment of the present invention;

FIG. 3 is a plan view of the touch screen of FIG. 2;

FIGS. 4 and 5 are a cross-sectional view and a plan view for explaining an operational method of the touch screen of FIG. 2.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

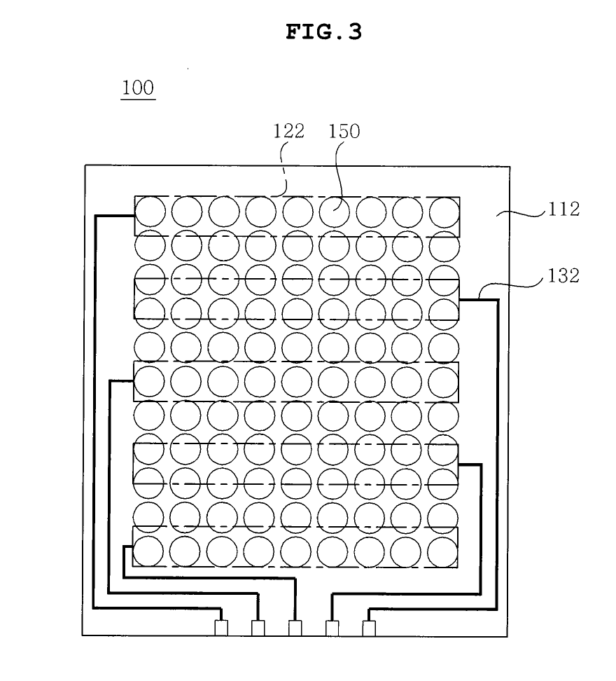

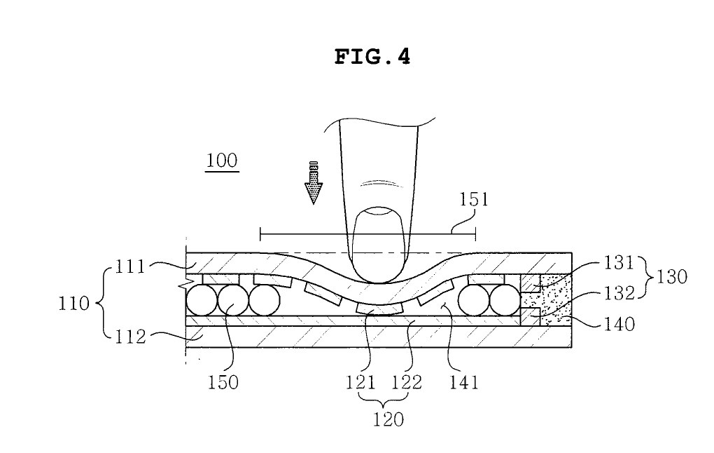

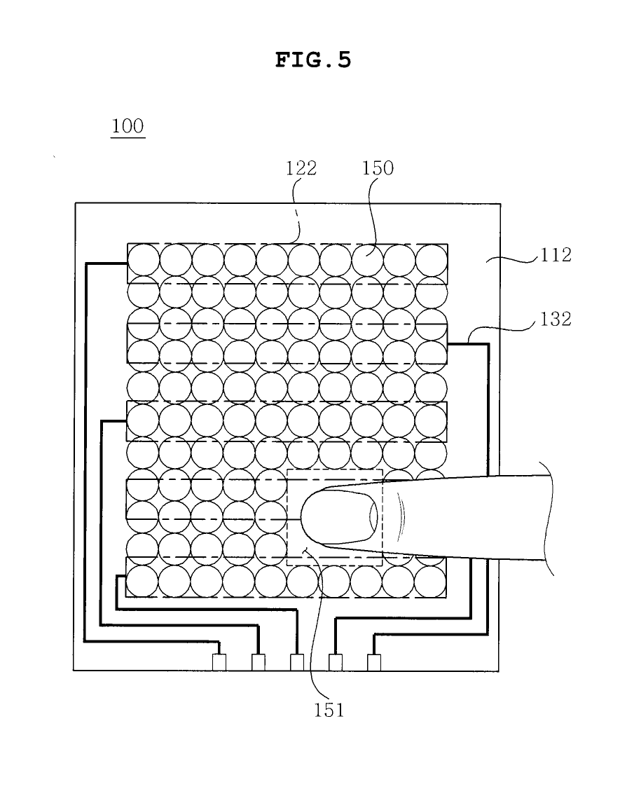

FIG. 2 is a cross-sectional view of a touch screen 100 according to a preferred embodiment of the present invention, FIG. 3 is a plan view of the touch screen 100 of FIG. 2, and FIGS. 4 and 5 are a cross-sectional view and a plan view for explaining an operational method of the touch screen 100 of FIG. 2. Hereinafter, the touch screen 100 according to the present embodiment will be described with reference to these figures.

Herein, a first transparent substrate 111, a first transparent electrode 121, a first electrode 131, and an adhesive layer 140 are not shown in FIGS. 3 and 5 for convenience of explanation. The touch screen 100 according to the present embodiment conceptually includes all of the components.

As shown in FIGS. 2 and 3, the touch screen 100 according to the present embodiment includes a transparent substrate 110, a transparent electrode 120, an electrode 130, an adhesive layer 140, and a dot spacer 150, wherein the dot spacer 150 is movably designed.

The transparent substrate 110 may include two sheets of a first transparent substrate 111 and a second transparent substrate 112.

Herein, the first transparent substrate 111, which is a member receiving pressure from a specific object such as a user's body, a stylus pen, or the like, is provided with a first transparent electrode 121 formed on one surface thereof. In addition, since the first transparent substrate 111 is a member which is bent when pressure is applied, it is preferable that the first transparent substrate 111 is made of a material having elasticity so that it is returned to its original position when the pressure is released. The first transparent substrate 111 may have a film shape made of a transparent material having elasticity, for example, polyethyleneterephthalate (PET), polycarbonate (PC), polymethylmetacrylate (PMMA), polyethylenenaphthalate (PEN), polyethersulfone (PES) or cyclic olefin copolymer (COC). Besides, glass or tempered glass may be generally used. Meanwhile, it is also possible to protect the touch screen 100 by forming a separate window plate (not shown) on an upper portion of the first transparent substrate 111.

The second transparent substrate 112, which is a member formed to face the first transparent substrate 111, is provided with a second transparent electrode 122 formed on one surface thereof. Herein, the second transparent substrate 112 may be made of the same transparent material as that of the first transparent substrate 111 but does not necessarily have elasticity as in the first transparent substrate 111.

Meanwhile, since each of the transparent electrodes 120 is formed on the transparent substrates 110, it is preferable that one surface of the transparent substrate 110 is subjected to a high-frequency treatment or a primer treatment in order to improve adhesion with the transparent electrode 120.

The transparent electrodes 120 are members that are formed on each of the transparent substrates 110 to be in contact with each other, thereby sensing signals of the touched input.

Herein, the transparent electrode 120 may be configured of a first transparent electrode 121 and a second transparent electrode 122, wherein the first transparent electrode 121 may be formed on the first transparent substrate 111 and the second transparent electrode 122 may be formed on the second transparent substrate 112, while being opposite to each other. In addition, the first transparent electrode 121 is in contact with the second transparent electrode 122 due to the pressure applied to the first transparent substrate 111 to provide a change in voltage or resistance and to allow a controller (not shown) to recognize pressed coordinates based thereon, such that the controller (not shown) may implement a desired operation by recognizing the coordinates of the pressed positions.

In addition, the first transparent electrode 121 and the second transparent electrode 122 may be formed in a bar shape, orthogonal to each other, so that they can recognize an X-axis coordinate and a Y-axis coordinate, respectively. However, they are not limited thereto but they may also have various shapes such as a diamond shape, a hexagonal shape, an octagonal shape, a triangular shape, or the like. In addition, in a case of an analog resistive touch screen, the transparent electrode 120 may be formed to have a film shape over the transparent substrate 110 except for the edges of the transparent substrate 110.

Meanwhile, the transparent electrodes 120 are made of a transparent material for a user to be able to see the display (not shown) under them, and preferably have conductivity. The transparent electrode 120 may, for example, be made of a conductive polymer containing poly-3,4-ethylenedioxythiophene/polystyrenesulfonate (PEDOT/PSS), polyaniline alone or a mixture thereof, or metal oxides, such as indium tin oxide (ITO). At this time, when the transparent electrode 120 is made of a metal oxide, it may be coated on the transparent substrate 110 by deposition, development, etching and the like, and when the transparent electrode 120 is made of a conductive polymer, it may be formed on the transparent substrate 110 by silk screen printing, inkjet printing, gravure printing, offset printing, or the like.

The electrode 130 is a member that is electrically connected to the transparent electrode 120 to supply voltage to the transparent electrode 120.

Herein, the electrode 130 is configured of a first electrode 131 and a second electrode 132, wherein the first electrode 131 may be formed on one surface of the first transparent substrate 111 to be connected to the first transparent electrode 121 and the second electrode 132 may be formed on one surface of the second transparent substrate 112 to be connected to the second transparent electrode 122. In addition, it is preferable that the electrode 130 is made of a material having excellent electrical conductivity so as to supply voltage to the transparent electrode 120. For example, the electrode 130 may be made of a material composed of silver (Ag) paste or organic silver. In addition, the electrode 130 is formed on the outer side of the transparent substrate 110, such that it is not necessarily required to be made of a transparent material.

The adhesive layer 140 is a member that is provided on the outer side between surfaces of each of the transparent substrates 111 and 112 on which the transparent electrodes 120 are formed.

Herein, the adhesive layer 140 may be formed of, for example, a double-sided adhesive tape (DAT), thereby making it possible to mutually bond the first transparent substrate 111 to the second transparent substrate 112. In addition, the adhesive layer 140 is provided on the outer side between the transparent substrates 111 and 112 so that the first transparent electrode 121 is in contact with the second transparent electrode 122 on the inner side between the transparent substrates 111 and 112 by the touched input, such that an opening 141 may be formed on the inner side of the adhesive layer 140. Meanwhile, the electrode 130 is formed on the outer side of the transparent substrate 110, such that it may be impregnated into the adhesive layer 140.

The dot spacer 150 is a member that is movably formed on the inner side between the transparent substrates 111 and 112.

Herein, the dot spacer 150 lessens the impact generated when the first transparent electrode 121 is in contact with the second transparent electrode 122 and provides repulsive force so that the first transparent substrate 111 is returned to its original position when the pressure is released. In addition, the dot spacer 150 usually serves to maintain insulation between the transparent electrodes 120 so that the first transparent electrode 121 is not in contact with the second transparent electrode 122 when there is no external pressure.

Meanwhile, the dot spacer 150 may be formed on the inner side between the first transparent substrate 111 and the second transparent substrate 112, that is, in the opening 141 of the adhesive layer 140. In addition, the dot spacer 150 may be configured in plural and be movably designed. In addition, it is preferable that the dot spacer 150 has a spherical shape so as to be easily moved. However, the dot spacer 150 is not limited thereto but may have any movable shape.

In addition, the opening 141 of the adhesive layer 140, in which the dot spacers 150 are positioned, may be filled with a lubrication member, thereby further facilitating the movement of the dot spacers 150. Herein, as the lubrication member, a transparent crystal or the like may be used, thereby making it possible to facilitate the movement of the dot spacer 150 and relieve a difference in refractive index.

A phenomenon that the dot spacers 150 move when the touched input is applied will be described.

As shown in FIGS. 4 and 5, when a touched input is applied, the dot spacers 150 move to form a touched region 151 within the opening 141. More specifically, since the dot spacers 150 are movable within the opening 141, the dot spacers 150 are pushed and moved to the outer side of the spot where the touched input is generated by the pressure of the touched input when the touched input is applied and the dot spacers 150 may be closely adhered to each other in regions except for the touched region 151 in which the first transparent electrode 121 is in contact with the second transparent electrode 122. In other words, only one region providing a space in which the first transparent electrode 121 may be in contact with the second transparent electrode 122 becomes the touched region 151, and the plurality of dot spacers 150 may be closely adhered to each other in other regions. In addition, the touched region 151 may be changed according to the positions of the touched input and the intervals between the dot spacers 150 may be changed, thereby making it possible to accurately measure the positions of the touched input.

Herein, a width of the touched region 151 may be 78.5 mm² or less. More specifically, a diameter of the region in which the first transparent substrate 111 is touched by a finger may be about 8 to 10 mm and a diameter of the dot spacer may be about 20 to 40 μm, such that the region in which the first transparent electrode 121 is in contact with the second transparent electrode 122 may have a width of about 78.5 mm². In addition, when a multi-touch is available, for example, when two points can be simultaneously measured, a width of the touched region 151 may be 157 mm² or less, equivalent to the double of 78.5 mm², and when three points can be simultaneously measured, a width of the touched region 151 may be 235.5 mm² or less.

Meanwhile, the dot spacer 150 is not formed on the transparent electrode 120 but is previously cured to be simply filled in the opening 141 of the adhesive layer 140, such that a process thereof is relatively simple. Therefore, manufacturing costs and manufacturing time of the touch screen 100 can be reduced.

With the touch screen according to the present invention, the dot spacers are moved to the outer side of the touched region when the touched input is generated and the first transparent electrode is in contact with the second transparent electrode in the touched region, thereby making it possible to accurately sense the positions of the touched input.

In addition, according to the present invention, the dot spacers of which manufacturing is completed are simply filled in the opening of the adhesive layer, thereby making it possible to reduce manufacturing costs and manufacturing time of the touch screen.

In addition, according to the present invention, the opening of the adhesive layer is filled with the lubrication member, thereby making it possible to smoothly move the dot spacers.

Although the embodiment of the present invention has been disclosed for illustrative purposes, it will be appreciated that a touch screen according to the invention is not limited thereby, and those skilled in the art will appreciate that various modifications, additions and substitutions are possible, without departing from the scope and spirit of the invention.

Accordingly, such modifications, additions and substitutions should also be understood to fall within the scope of the present invention.

What is claimed is:

1. A touch screen, comprising:
a first transparent electrode formed on a first transparent substrate;
a second transparent electrode formed on a second transparent substrate opposite to the first transparent substrate and being in contact with the first transparent electrode when a touched input is generated to sense a change in resistance or voltage;
an adhesive layer bonding an outer side of the first transparent substrate to an outer side of the second transparent substrate and having an opening formed therein; and
a plurality of dot spacers movably formed in the opening.

2. The touch screen as set forth in claim 1, wherein when the touched input is generated, the plurality of dot spacers are moved and closely adhered to each other in the opening and the first transparent electrode is in contact with the second transparent electrode in a touched region that is a space between the plurality of dot spacers.

3. The touch screen as set forth in claim 2, wherein a width of the touched region is 78.5 mm² or less.

4. The touch screen as set forth in claim 1, wherein the dot spacer has a spherical shape.

5. The touch screen as set forth in claim 1, further comprising electrodes formed on each of the first transparent substrate and the second transparent substrate to apply voltage to the first transparent electrode and the second transparent electrode.

6. The touch screen as set forth in claim 1, further comprising a lubrication member filled in the opening.

7. The touch screen as set forth in claim 1, wherein a diameter of the dot spacer is 20 to 40 μm.
